(19) United States
(12) Patent Application Publication
(10) Pub. No.: US 2024/0319335 A1
(43) Pub. Date: Sep. 26, 2024

(54) SCALING MODULE, AND CALIBRATION METHOD AND USE METHOD THEREFOR

(71) Applicant: National Institute of Metrology, Beijing (CN)

(72) Inventors: Haiyong GAN, Beijing (CN); Yingwei HE, Beijing (CN); Houping WU, Beijing (CN); Yingce WANG, Beijing (CN); Donglin MENG, Beijing (CN); Hao XU, Beijing (CN); Xiao LIU, Beijing (CN)

(73) Assignee: National Institute of Metrology, Beijing (CN)

(21) Appl. No.: 18/733,573

(22) Filed: Jun. 4, 2024

Related U.S. Application Data
(63) Continuation of application No. PCT/CN2022/122052, filed on Sep. 28, 2022.

(30) Foreign Application Priority Data
Jun. 27, 2022 (CN) 202210743541.8

(51) Int. Cl. G01S 7/40

(52) U.S. Cl. CPC G01S 7/4091

(57) ABSTRACT

A scaling module, and a calibration method and use method therefore, relating to the technical field of reflection detection. The scaling module comprises a three-dimensional scaler (1); the three-dimensional scaler (1) comprises a microwave reflective layer (11) and an optical reflective layer (12); the microwave reflective layer (11) has a first scaling surface, and the optical reflective layer (12) has a second scaling surface; the first scaling surface is divided into a plurality of first scaling areas, the plurality of second scaling surfaces are divided into a plurality of second scaling areas, and the plurality of first scaling areas and the plurality of second scaling areas are arranged in a one-to-one correspondence manner; the microwave reflective layer (11) is used for reflecting microwaves emitted by a synthetic aperture radar, and the optical reflective layer (12) is used for reflecting light to an optical imaging device.

### CROSS-REFERENCE TO RELATED APPLICATION

The present application is a continuation of International Patent Application Number PCT/CN2022/122052 filed Sep. 28, 2022, which claims priority to Chinese patent application No. 202210743541.8 filed on Jun. 27, 2022, the contents of which are incorporated herein by reference in their entireties.

### FIELD

The present application relates to the field of reflection detection, and particular to a scaling module and a calibration method and a usage method thereof.

### BACKGROUND

In a traditional process of detecting parameters such as distance and speed of a target, it is usually necessary to calibrate a detection device with a calibration target, or to calibrate separately through multiple calibration methods and then fuse them together. The calibration process is therefore cumbersome and low in accuracy.

### SUMMARY

The present application provides a scaling module and a calibration method and a usage method thereof, which solves or alleviates the problem that calibration process of a traditional detection device is cumbersome and low in accuracy of calibration.

The present application provides a scaling module, including: a three-dimensional scaler, where the three-dimensional scaler includes a microwave reflective layer and an optical reflective layer; the microwave reflective layer has a first scaling surface, and the optical reflective layer has a second scaling surface; the first scaling surface is divided into a plurality of first scaling regions, the second scaling surface is divided into a plurality of second scaling regions, and the plurality of first scaling regions are in one-to-one correspondence with the plurality of the second scaling regions; the microwave reflective layer is used to reflect microwaves emitted by synthetic aperture radar, and the optical reflective layer is used to reflect light toward an optical imaging device.

According to a scaling module provided by the present application, the optical reflective layer is provided on the microwave reflective layer, a side of the microwave reflective layer facing the optical reflective layer is attached to the optical reflective layer, and a shape and a size of the corresponding first scaling region and the second scaling region are the same.

According to a scaling module provided by the present application, the optical reflective layer is adhered to the microwave reflective layer.

According to a scaling module provided by the present application, the optical reflective layer is detachably connected to the microwave reflective layer.

According to a scaling module provided by the present application, at least two first scaling regions among the plurality of first scaling regions have different microwave reflection characteristics.

According to a scaling module provided in the present application, at least two second scaling regions among the plurality of second scaling regions have different optical reflection characteristics.

According to a scaling module provided by the present application, the optical reflective layer encloses a sealed cavity, and the microwave reflective layer is provided in the cavity.

According to a scaling module provided by the present application, shapes of the cavity include a regular tetrahedron, a regular hexahedron, a regular octahedron, a regular dodecahedron and a regular icosahedron.

The present application further provides a calibration method of the scaling module as described above, including:
placing the scaling module in a radar cross section (RCS) standard measurement device to determine an RCS standard value of a first scaling surface on a three-dimensional scaler; and
placing the scaling module in an optical reflection spatial distribution characteristic standard measuring device to determine a standard value of optical reflection spatial distribution characteristic of the second scaling surface on the three-dimensional scaler.

The present application further provides a usage method of the scaling module as described above, including:
placing one or more calibrated scaling modules in an environment where a to-be-measured target is located, and calibrating a synthetic aperture radar and an optical imaging device using the scaling module.

In the scaling module and the calibration method and the usage method thereof provided by the present application, the three-dimensional scaler has both microwave reflection characteristics and optical reflection characteristics by providing the microwave reflection layer and the optical reflection layer. When the three-dimensional scaler is calibrated, the three-dimensional scaler is placed in an RCS standard device, each first scaling region on the first scaling surface is calibrated through the RCS standard device to obtain the RCS standard value of each first scaling region on the first scaling surface. The three-dimensional scaler is placed in the optical reflection distribution standard device, each second scaling region on the second scaling surface is calibrated through the optical reflection distribution standard device to obtain the optical diffuse reflection standard value of each second scaling region on the second scaling surface. By assigning values to the microwave reflection characteristics and optical reflection characteristics of the three-dimensional scaler, the three-dimensional scaler with standard values is obtained. By the three-dimensional scaler with standard values, the synthetic aperture radar and optical imaging device may be simultaneously calibrated, which reduces the calibration steps and improves the efficiency and accuracy of calibration without fusing separately after calibration. In addition, the three-dimensional scaler has good versatility, especially when a three-dimensional target is detected, the three-dimensional scaler may meet calibration requirements from multiple dimensions, which improves the accuracy of calibration, and thus improves the detection precision of the calibrated synthetic aperture radar and optical imaging device.

### BRIEF DESCRIPTION OF THE DRAWINGS

To illustrate the solutions of the embodiments according to the present application or the related art, the accompanying drawings used in the description for the embodiments or the related art are briefly described below. It should be noted that the drawings in the following description are only some embodiments of the present application. For those of ordinary skill in the art, other drawings may be obtained according to these drawings without creative effort.

FIG. 1 is a schematic structural diagram of a three-dimensional scaler according to the present application;

FIG. 2 is a schematic cross-sectional structural diagram of a three-dimensional scaler according to the present application;

FIG. 3 is a schematic flow chart of a calibration method of a three-dimensional scaler according to the present application; and

FIG. 4 is a schematic flow chart of a usage method of a three-dimensional scaler according to the present application.

### REFERENCE SIGNS

1: three-dimensional scaler; 11: microwave reflective layer; 12: optical reflective layer.

### DETAILED DESCRIPTION

To illustrate the solutions and advantages of the embodiments more clearly according to the present application, the solutions in the embodiments of the present application are clearly and completely described below in conjunction with the accompanying drawings in the embodiments of the present application. It should be noted that, the described embodiments are part of the embodiments of the present application, but not all of the embodiments. Based on the embodiments in this application, all other embodiments obtained by those of ordinary skill in the art without creative efforts fall within the scope of protection of this application.

In the description of the present application, it should be noted that, the orientation or positional relations specified by terms such as “inner”, “outer” and the like, are based on the orientation or positional relations shown in the drawings, which is merely for convenience of description of the present application and to simplify description, but does not indicate or imply that the stated devices or components must have a particular orientation and be constructed and operated in a particular orientation, and thus it is not to be construed as limiting the present application. Furthermore, the terms “first”, “second”, “third” and the like are only used for descriptive purposes and should not be construed as indicating or implying a relative importance.

In the description of the embodiments of the present application, it should be noted that, unless otherwise clearly stated and limited, the terms “connected with” and “connected to” should be understood in a broad sense. For example, they may indicate fixedly connected or detachably connected, or integratedly connected; they may indicate mechanically connected or electrically connected; they may indicate directly connected or indirectly connected through an intermediate medium. For those of ordinary skill in the art, the specific meanings of the above terms in the embodiments of the present application can be understood in specific situations.

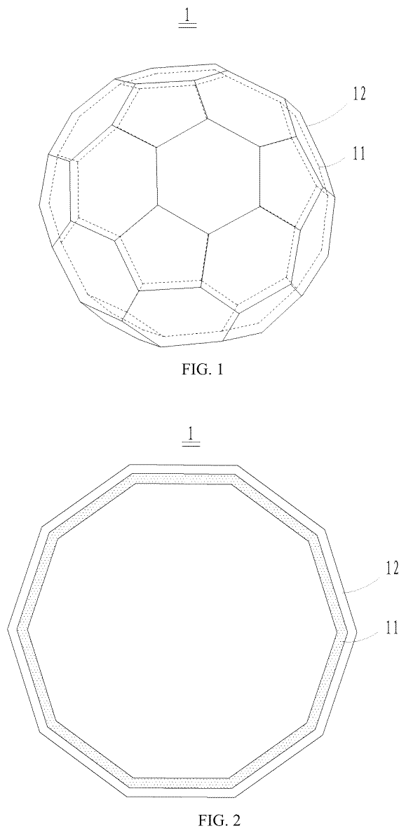

A scaling module and a calibration method and a usage method thereof according to the present application are described below in conjunction with FIG. 1 to FIG. 4.

As shown in FIG. 1 and FIG. 2, the scaling module shown in the embodiment includes a three-dimensional scaler 1.

The three-dimensional scaler 1 includes a microwave reflective layer 11 and an optical reflective layer 12. The microwave reflective layer 11 has a first scaling surface, and the optical reflective layer 12 has a second scaling surface; the first scaling surface is divided into a plurality of first scaling regions, the second scaling surface is divided into a plurality of second scaling regions, and the plurality of first scaling regions are in one-to-one correspondence with the plurality of the second scaling regions; the microwave reflective layer 11 is used to reflect microwaves emitted by synthetic aperture radar, and the optical reflective layer 12 is used to reflect light toward an optical imaging device. The first scaling surface encloses a three-dimensional structure, and the second scaling surface encloses a three-dimensional structure.

In the scaling module provided by the present application, the three-dimensional scaler 1 has both microwave reflection characteristics and optical reflection characteristics by providing the microwave reflection layer 11 and the optical reflection layer 12. When the three-dimensional scaler 1 is calibrated, the three-dimensional scaler 1 is placed in an RCS standard device, each first scaling region on the first scaling surface is calibrated through the RCS standard device to obtain an RCS standard value of each first scaling region on the first scaling surface. The three-dimensional scaler 1 is placed in the optical reflection distribution standard device, each second scaling region on the second scaling surface is calibrated through the optical reflection distribution standard device to obtain an optical diffuse reflection standard value of each second scaling region on the second scaling surface. By assigning values to the microwave reflection characteristics and optical reflection characteristics of the three-dimensional scaler, the three-dimensional scaler with standard values is obtained. By the three-dimensional scaler with standard values, the synthetic aperture radar and the optical imaging device may be simultaneously calibrated, which reduces the calibration steps and improves the efficiency and accuracy of calibration without fusing separately after calibration. In addition, the three-dimensional scaler 1 has good versatility, especially when a three-dimensional target is detected, the three-dimensional scaler 1 may meet calibration requirements from multiple dimensions, which improves the accuracy of calibration, and thus improves the detection precision of the calibrated synthetic aperture radar and optical imaging device.

It should be noted that the first scaling region is provided with a carbon powder layer or a hydroxyl iron layer. When the first scaling region is provided with the carbon powder layer, a concentration of carbon powder in the carbon powder layer may be adjusted, or a thickness of the carbon powder layer may be adjusted to change the reflectivity of the microwave reflective layer. When the first scaling region is provided with the hydroxyl iron layer, a concentration of hydroxyl iron in the hydroxyl iron layer may be adjusted, or a thickness of the hydroxyl iron layer may be adjusted to change the reflectivity of the microwave reflective layer. In FIG. 1, the microwave reflective layer is represented by a dotted line, and the optical reflective layer is represented by a solid line.

In an embodiment, as shown in FIG. 2, the optical reflective layer 12 shown in the embodiment is provided on the microwave reflective layer 11, a side of the microwave reflective layer 11 facing the optical reflective layer 12 is attached to the optical reflective layer 12, and a shape and a size of the corresponding first scaling region and the second scaling region are the same.

The optical reflective layer 12 is completely attached to the microwave reflective layer 11, and the shape and the size of the corresponding first scaling region and the second scaling region are the same, that is, the corresponding first scaling region and second scaling region have a same boundary to avoid interference between two adjacent first scaling regions and two adjacent second scaling regions during the assignment or calibration process.

Shapes of the first scaling region and the second scaling region include triangles, quadrilaterals, pentagons or hexagons, etc. FIG. 1 illustrates pentagons and hexagons.

It should be noted that since the optical reflective layer 12 is attached to the microwave reflective layer 11, an area of the second scaling region is theoretically slightly larger than an area of the first scaling region, but the thickness of the optical reflective layer 12 is small, the influence of the thickness of the optical reflection layer on the area size of the second scaling region can be ignored, and it can be considered that the first scaling region and the second scaling region have the same shape and size, and thus have the same boundary.

In an embodiment, the optical reflective layer 12 shown in the embodiment is adhered to the microwave reflective layer 11.

Paint may be sprayed on the microwave reflective layer 11, and the optical reflective layer 12 is formed by sprayed paint, which improves the convenience of manufacturing the optical reflective layer 12. The microwaves emitted by the synthetic aperture radar may pass through the optical reflective layer 12 and be reflected by the microwave reflective layer 11.

In an embodiment, the optical reflective layer 12 is detachably connected to the microwave reflective layer 11.

The microwave reflection layer 11 can be covered by an optical reflection plate, and the optical reflection plate may form the optical reflection layer 12. Different optical reflection plates may be flexibly replaced according to different calibration requirements; the microwaves emitted by the synthetic aperture radar may pass through the optical reflective layer 12 and be reflected by the microwave reflective layer 11.

In an embodiment, at least two first scaling regions among the plurality of first scaling regions have different microwave reflection characteristics. It can be understood that the first scaling surface has at least two microwave reflection characteristics. After assigning values to the plurality of first scaling regions respectively on the first scaling surface, the first scaling surface has a plurality of RCS standard values and thus the three-dimensional scaler 1 has more comprehensive calibration performance, which improves the accuracy of calibration of the synthetic aperture radar.

In an embodiment, at least two second scaling regions among the plurality of second scaling regions have different optical reflection characteristics. It can be understood that the second scaling surface has at least two optical reflection characteristics. After assigning values to the plurality of second scaling regions respectively on the second scaling surface, the second scaling surface has a plurality of optical diffuse reflection standard values and thus the three-dimensional scaler 1 has more comprehensive calibration performance, which improves the accuracy of calibration of the optical imaging device.

In an embodiment, as shown in FIG. 1, the optical reflective layer 12 encloses a sealed cavity, and the microwave reflective layer 11 is provided in the cavity.

The optical reflective layer 12 encloses a three-dimensional structure, therefore the entire three-dimensional scaler 1 has a three-dimensional shape. The microwave reflective layer 11 and the optical reflective layer are arranged oppositely, and the entire microwave reflective layer 11 also has a three-dimensional shape. When a three-dimensional target is detected, the three-dimensional scaler 1 may meet the calibration requirements of synthetic aperture radar and optical imaging device in multiple dimensions.

To ensure the stability of the microwave reflection layer 11 and the optical reflection layer 12, a skeleton is provided in the microwave reflection layer 11, the microwave reflection layer 11 is attached to the skeleton, and the optical reflection layer 12 is provided on the microwave reflection layer 11.

Furthermore, the traditional corner reflector may also be modified, and the microwave reflection layer 11 and the optical reflection layer 12 are sequentially provided on each reflecting surface of the corner reflector, and thus the modified corner reflector has both microwave reflection characteristics and the optical reflection characteristics to simultaneously calibrate the synthetic aperture radar and the optical imaging device, which reduces the calibration steps and improves the efficiency of calibration without fusing separately after calibration.

In an embodiment, shapes of the cavity enclosed by the optical reflection layer 12 include a regular tetrahedron, a regular hexahedron, a regular octahedron, a regular dodecahedron and a regular icosahedron.

By setting the optical reflection layer 12 into a regular polyhedron, the shape of the three-dimensional scaler 1 is relatively uniform, the calibration requirements of synthetic aperture radar and optical imaging device from multiple angles may be met and calibration blind spots may be avoided. Except for setting the optical reflection layer 12 into the regular polyhedron, polyhedrons of corresponding shapes can also be set based on the actual calibration environment.

As shown in FIG. 3, the present application further provides a calibration method of the scaling module as described above, which includes the following steps:

S310: placing the scaling module in a radar cross section (RCS) standard measurement device to determine an RCS standard value of a first scaling surface on a three-dimensional scaler; and

S320: placing the scaling module in an optical reflection spatial distribution characteristic standard measuring device to determine a standard value of optical reflection spatial distribution characteristic of the second scaling surface on the three-dimensional scaler.

By assigning values to a plurality of first scaling regions on the first scaling surface, and assigning values to a plurality of second scaling regions on the second scaling surface, the scaling module is rendered a scaler with standard values.

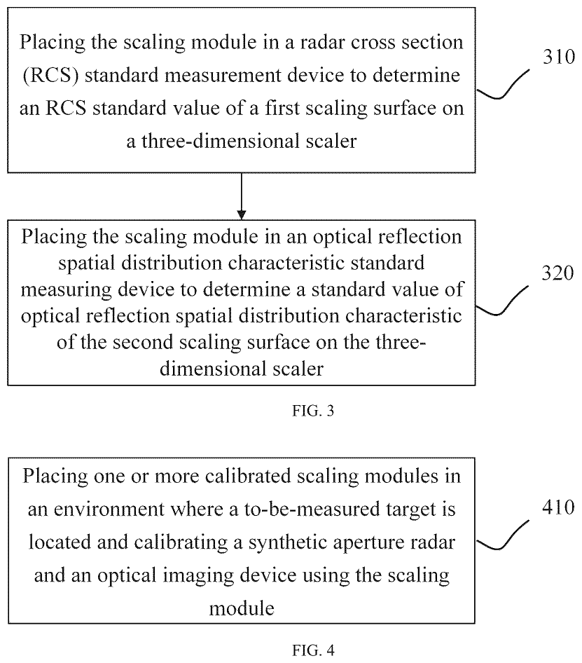

As shown in FIG. 4, the present application further provides a usage method of the scaling module as described above, including:

S410: placing one or more calibrated scaling modules in an environment where a to-be-measured target is located, and calibrating a synthetic aperture radar and an optical imaging device using the scaling module.

Since the scaling module has both microwave reflection characteristics and optical reflection characteristics, the synthetic aperture radar and optical imaging device may be calibrated without replacing the scaling module. No fusion calculation is required, which improves the efficiency and accuracy of calibration. The calibrated synthetic aperture radar and optical imaging device are used to detect a to-be-measured object.

It should be noted that the above embodiments are only used to explain the solutions of the present application, and are not limited thereto. Although the present application has been described in detail with reference to the foregoing embodiments, it should be understood by those skilled in the art that modifications to the solutions documented in the foregoing embodiments and equivalent substitutions to a part of the features can be made and these modifications and substitutions do not make the corresponding solutions depart from the scope of the solutions of various embodiments of the present application.

What is claimed is:

1. A scaling module, comprising:
a three-dimensional scaler, wherein the three-dimensional scaler comprising a microwave reflective layer and an optical reflective layer,
wherein the microwave reflective layer has a first scaling surface, and the optical reflective layer has a second scaling surface; the first scaling surface is divided into a plurality of first scaling regions, the second scaling surface is divided into a plurality of second scaling regions, and the plurality of first scaling regions are in one-to-one correspondence with the plurality of the second scaling regions;
the microwave reflective layer is used to reflect microwaves emitted by synthetic aperture radar, and the optical reflective layer is used to reflect light toward an optical imaging device.

2. The scaling module of claim 1, wherein the optical reflective layer is provided on the microwave reflective layer, a side of the microwave reflective layer facing the optical reflective layer is attached to the optical reflective layer, and a shape and a size of the corresponding first scaling region and the second scaling region are the same.

3. The scaling module of claim 2, wherein the optical reflective layer is adhered to the microwave reflective layer.

4. The scaling module of claim 2, wherein the optical reflective layer is detachably connected to the microwave reflective layer.

5. The scaling module of claim 1, wherein at least two first scaling regions among the plurality of first scaling regions have different microwave reflection characteristics.

6. The scaling module of claim 1, wherein at least two second scaling regions among the plurality of second scaling regions have different optical reflection characteristics.

7. The scaling module of claim 1, wherein the optical reflective layer encloses a sealed cavity, and the microwave reflective layer is provided in the cavity.

8. The scaling module of claim 7, wherein shapes of the cavity comprise a regular tetrahedron, a regular hexahedron, a regular octahedron, a regular dodecahedron and a regular icosahedron.

9. A calibration method of the scaling module of claim 1, comprising:
placing the scaling module in a radar cross section (RCS) standard measurement device to determine an RCS standard value of a first scaling surface on a three-dimensional scaler; and placing the scaling module in an optical reflection spatial distribution characteristic standard measuring device to determine a standard value of optical reflection spatial distribution characteristic of the second scaling surface on the three-dimensional scaler.

10. A usage method of the scaling module of claim 1, comprising:
placing one or more calibrated scaling modules in an environment where a to-be-measured target is located and calibrating a synthetic aperture radar and an optical imaging device using the scaling module.
